(19) United States
(12) Patent Application Publication
(10) Pub. No.: US 2022/0178416 A1
(43) Pub. Date: Jun. 9, 2022

(54) FLEXIBLE SPRING ELEMENT MADE OF A FIBRE-PLASTIC COMPOSITE MATERIAL

(71) Applicants: DANTO Invention GmbH & Co. KG, Stockstadt am Rhein (DE); Rheinmetall Invent GmbH, Neckarsulm (DE)

(72) Inventors: Anna SCHWARZ, Dittelsheim-Heßloch (DE); Tobias KELLER, Dittelsheim-Heßloch (DE)

(21) Appl. No.: 17/602,759

(22) PCT Filed: Jan. 30, 2020
(86) PCT No.: PCT/EP2020/052358

§ 371 Date: Oct. 10, 2021

(30) Foreign Application Priority Data
Apr. 11, 2019 (DE) 10 2019 109 554.9

(51) Int. Cl. F16F 1/368; F16F 1/373

(52) U.S. Cl. CPC F16F 1/368; F16F 2224/0241; F16F 2236/02; F16F 1/373

(57) ABSTRACT

A flexible spring element is made of a fiber-plastic composite material and has a cover layer made of a first fiber-plastic composite material on each of two outer sides lying opposite one another. Fibers are aligned parallel relative to one another at least in bundles within the cover layers and run parallel to the outer side associated with the respective cover layer. A curved portion extends where a center plane of the unloaded flexible spring element runs in a curved manner in a longitudinal direction of the flexible spring element. At least one longitudinal portion extends where the center plane of the unloaded flexible spring element has no significant curvature or has a reversal of curvature. In the curved portion the flexible spring element has a spacing extending element arranged between the two cover layers that is made of a different material than the two cover layers.

### TECHNICAL FIELD

The disclosure relates to a flexible spring element made of a fiber-plastic composite material.

### BACKGROUND

A flexible spring element can be designed in one piece and form a flexible spring or a flexible spring device. It is likewise possible that several flexible spring elements are combined into a flexible spring device and brought into interaction with one another. A single flexible spring element can be designed in a bar shape, for example, and have a straight or slightly curved progression. Flexible spring elements are also known that have a complex curved progression and a C-shaped or S-shaped design, for example, or several alternating curves configured in a meandering pattern.

Flexible spring elements can be produced from various materials. Conventional flexible spring elements are often manufactured from suitable spring steel, for example. Flexible spring elements of this kind can be produced inexpensively, it being possible to adapt the shape of the flexible spring elements to the respective task. Flexible spring elements made of spring steel or of another suitable metal are robust and have advantageous spring properties.

It is likewise known and has already been tested for various application areas to manufacture flexible spring elements from a suitable fiber-plastic composite material. In this case a fiber-plastic composite material is normally used in which quasi-endless fibers are embedded in a suitable matrix material made of plastic. Due to the arrangement and orientation of the individual fibers, which are essentially responsible for a tension and compression transmission along the flexible spring element, advantageous spring properties can be favored. Compared with flexible spring elements made of metal, flexible spring elements made of a fiber-plastic composite material can have a lower weight and better resistance to ambient conditions and in particular to humidity. Flexible spring elements made of a suitable fiber-plastic composite material can be used advantageously in motor vehicles.

The manufacture of flexible spring elements from a fiber-plastic composite material is often associated with a high manufacturing outlay and thus accompanied by high manufacturing costs, however. In the case of flexible spring elements of varying thickness in particular, the effort involved in preparing a large number of prefabricated strips of fiber-plastic composite material or prepregs of varying length, arranging them in a tool mold and subsequently pressing them is quite considerable and often decisive with regard to the production costs.

A flexible spring element configured as a substantially flat leaf spring is described in U.S. Pat. No. 3,968,958, for example. The prefabrication of the prefabricated prepregs of varying length and in particular their arrangement in a tool mold and their fixing during the curing process of the prepregs in the tool mold, which takes place under pressure, is associated with a considerable effort, which can often only be carried out manually. A central portion of the leaf spring is additionally reinforced by the additional central layers formed shorter and arranged between the outer cover layers.

In the case of a flexible spring element with a curved portion, in which the progression of the flexible spring element varies at least by more than 90°, but by approximately 180° in many practical applications, the curved portion is often formed thicker than an adjacent longitudinal portion in which the progression of the flexible spring element does not change or at any rate does not change significantly. The flexible spring element is subjected to higher loading in the curved portion in the event of a force directed transversely to the progression in the longitudinal direction. In the case of an intended deflection of the flexible spring element here due to the force acting on it, a cover layer portion arranged directed outwardly in the curved portion is subjected to tensile loading and an opposing cover layer portion directed inwardly in the curved portion is subjected to compressive loading, while the cover layer portions in an adjacent longitudinal portion of the flexible spring element are subjected to lower tensile or compressive loading.

If the flexible spring element is formed with a uniform thickness and with a uniform spacing of the two cover layers, the thickness of the flexible spring element must be adapted to the tensile and compressive loading that can occur in the event of a maximally envisaged intended force on the curved portion of the flexible spring element. A much lower load occurs here in an adjacent longitudinal portion, so that the flexible spring element is over dimensioned in the case of a uniform thickness in this longitudinal portion. The weight of the flexible spring element and the material outlay would then be excessively great, which is regarded as disadvantageous with respect in particular to a lightweight construction method normally aspired to with fiber-plastic composite materials.

### SUMMARY

It is an object of the present disclosure to configure a flexible spring element made of a fiber-plastic composite material such that the flexible spring element can be produced inexpensively, can be adapted in a simple manner in various portions to the loads normally occurring and can have the most advantageous spring properties possible.

This object is achieved in a flexible spring element made of a fiber-plastic composite material. The flexible spring element comprises a cover layer made of a first fiber-plastic composite material on each of two outer sides lying opposite one another. Fibers are aligned parallel relative to one another at least in bundles within the cover layers and run parallel to the outer side associated with the respective cover layer. The flexible spring element comprises at least one curved portion, in which a center plane of the unloaded flexible spring element running with equal spacing between the two cover layers runs in a curved manner in a longitudinal direction of the flexible spring element. The flexible spring element comprises at least one longitudinal portion in which the center plane of the unloaded flexible spring element either has no significant curvature or has a reversal of curvature. In an intended deflection of the flexible spring element, a cover layer portion arranged directed outwardly in the curved portion is subjected to tensile loading and an opposing cover layer portion directed inwardly in the curved portion is subjected to compression loading.

The flexible spring element has exclusively the two cover layers in the at least one longitudinal portion. In the at least one curved portion the flexible spring element has a spacing extending element arranged between the two cover layers that is made of a different material than the two cover layers. It has been shown that with a low material and production outlay, particularly advantageous spring properties can be made possible in a simple manner in that spacing extending elements are arranged in the at least one curved portion and preferably in several curved portions of the flexible spring element, due to which a thickness of the flexible spring element measured transversely to the longitudinal direction of the flexible spring element can be enlarged. The deformation forces occurring due to the bending load on the flexible spring element in the case of an intended load can be absorbed particularly advantageously by the spacing extending element of a curved portion thickened thereby and can be converted into spring energy. By increasing a spacing of the cover layers measured transversely to the longitudinal direction and thus a spacing of the cover layers from the center plane and the neutral fibers running therein, the flexible spring element has a greater deformation resistance in the curved portion than in an adjacent longitudinal portion without additional central layers that only extend beyond the curved portion having to be arranged for this purpose between the cover layers.

The spacing extending element arranged in the curved portion between the two cover layers has here a continuously varying thickness in the longitudinal direction, so that starting out from a first end tapering to a point, the spacing extending element becomes continuously thicker and has a maximum thickness in a central region, to taper increasingly towards the opposing second end and likewise taper to a point again. Abrupt changes in thickness, which can lead according to experience to load peaks and often extremely high and possibly excessive loading during an intended use of the flexible spring element, can be avoided in the flexible spring element in this way.

It is advantageous if the spacing extending element is manufactured from a material that is as resistant as possible to shear forces and has maximum shear rigidity. It is generally conceivable that the spacing extending element is manufactured from wood or a suitable plastic material, for example. The spacing extending element can be prefabricated or manufactured in advance, wherein the spacing extending element expediently already has a shape that is adapted to a shape or a progression of the unloaded flexible spring element within the curved portion.

According to an advantageous configuration, it is provided that the material of the spacing extending element is a second fiber-plastic composite material with fibers that have a respective length of less than 30 mm, preferably less than 10 mm and particularly preferably less than 1 mm. The second fiber-plastic composite material with such short fibers can be processed particularly advantageously and inexpensively and brought into the shape desired for the spacing extending element. The individual fibers can transmit no tensile or compressive forces over large areas in this case, which has proved not to be necessary, however. Due to the arrangement of a spacing extending element between two cover layers lying on the outside, a thickness of the flexible spring element measured transversely to a longitudinal direction of the flexible spring element can be adapted in the curved portion to the intended bending load of the flexible spring element and be configured considerably thicker than the overall thickness of the two cover layers. The spacing extending element produced from a second fiber-plastic composite material can have a low own weight. Due to the additional second fiber-plastic composite material of the spacing extending element, the two substantially more cost-intensive cover layers of the flexible spring element in the curved portion can be formed comparatively thin and adapted to the intended or maximally expected tensile and compressive loading of the cover layers of the flexible spring element within the curved portion.

It has turned out that the flexible spring element has particularly advantageous spring properties when the fibers in the second fiber-plastic composite material are arranged undirected. An undirected arrangement of this kind of the fibers embedded in the matrix material of the second fiber-plastic composite material is also termed randomly oriented fibers. In many applications it is the case that the more homogeneously the fibers are distributed in the second fiber-plastic composite material, the more advantageously the spring properties can be configured. The shorter the length of the individual fibers in the second fiber-plastic composite material, the more easily a homogeneous distribution of the fibers in the spacing extending element and a homogeneously distributed orientation of the individual fibers relative to one another can be created.

According to a particularly advantageous configuration, it is provided that the second fiber-plastic composite material has a plastic matrix material corresponding to the two cover layers. By using the same plastic matrix material for the cover layers and for the spacing extending element arranged between the cover layers, a transitionless substance-to-substance bonding of the spacing extending element with the adjacent cover layers on both sides can be achieved. Unintentional detachment of the cover layers from the spacing extending element is thereby avoided and at least made more difficult, even with high loading of the flexible spring element.

A spacing extending element can be produced by introducing a paste-like starting material between already prefabricated and if applicable pre-shaped cover layers. Depending on the material used, the spacing extending element can also be manufactured here using already known injection molding methods. The cover layers can then be joined together with the spacing extending element arranged in between and the desired flexible spring element produced thereby. The spacing extending element can also be introduced into the curved portion by already known injection molding methods between the cover layers already arranged in a tool mold. It is likewise conceivable for the spacing extending element to be manufactured in a separate work step separately from the cover layers. The cover layers can then be joined together with the spacing extending element arranged in between and molded and solidified into the desired flexible spring element.

It is optionally provided that the center plane in the at least one curved portion of the flexible spring element has a change of direction of more than 90°, preferably of more than 150° and particularly preferably of approximately 180°. In a curved portion, the progression of which in the longitudinal direction varies by more than 150° and preferably by approximately 180°, a force directed transversely to the two end regions of the curved portion due to an intended deformation of the flexible spring element within the curved portion can be absorbed particularly effectively and a high spring reset force and thus a great spring effect can be produced with a small space requirement.

According to one variant, it is provided in an advantageous manner that the flexible spring element has at least two curved portions that are separated from one another by a longitudinal portion and are curved in different directions, so that the center plane has an S-shaped progression over these two curved portions. Flexible spring elements with at least one spring portion formed S-shaped and in particular flexible spring elements with two or more S-shaped spring portions formed adjacent to one another enable a combination of a high spring force with a minimum space requirement, which is particularly advantageous for many applications. Several similar or structurally identical flexible spring elements can be combined into a flexible spring device that combines advantageous spring properties with a high resistance to environmental influences and a low own weight. A flexible spring element or a combined flexible spring device made of several flexible spring elements is therefore also particularly suitable for use as a spring element in motor vehicles.

The cover layers have particularly advantageous properties if the first fiber-plastic composite material of the two cover layers has fibers oriented unidirectionally in the longitudinal direction of the flexible spring element. Due to the fibers oriented unidirectionally and in the longitudinal direction, the cover layers can absorb particularly high tensile and compressive forces. Here the cover layers can have fibers or fiber bundles either running parallel to the longitudinal direction or running preferably at an acute angle to the longitudinal direction. Suitable fibers can be glass fibers, carbon fibers, ceramic fibers, basalt fibers, metal fibers or also natural fibers, for example. A suitable matrix material can be a plastic material adapted to the respective fibers such as a suitable thermoset, elastomer or thermoplastic, for example. The spacing extending element can have the same fibers as the cover layers or fibers produced from another material.

It is optionally provided that the first fiber-plastic composite material has fibers with a length that extends in the longitudinal direction over the entire flexible spring element. A tensile or compressive loading acting on the cover layers is thereby distributed by the quasi-endless fibers over the entire flexible spring element, whereby a risk of breaking in the event of excessive loading is reduced.

### BRIEF DESCRIPTION OF THE DRAWINGS

An exemplary embodiment, which is shown schematically in the drawing, is explained in greater detail below.

FIG. 1 is a schematic sectional view of a flexible spring element with an S-shaped progression.

FIG. 2 is a schematic sectional view of the flexible spring element shown in FIG. 1 along a line II-II in FIG. 1.

FIG. 3 is a schematic sectional view of the flexible spring element shown in FIG. 1 along a line in FIG. 1.

FIG. 4 is a schematic sectional view of a flexible spring element with several curved portions, which element is intended and suitable for use in a motor vehicle.

FIG. 5 is a schematic sectional view of a flexible spring element that is differently configured, but likewise provided for use in a motor vehicle.

### DETAILED DESCRIPTION

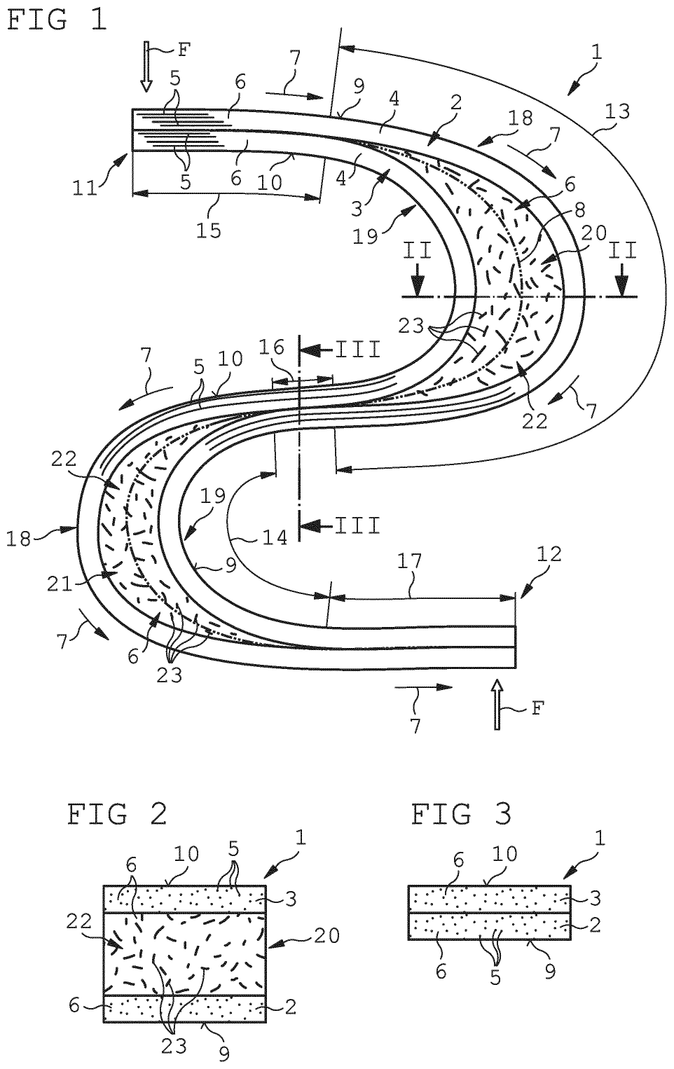

A flexible spring element 1 depicted in various views in FIGS. 1 to 3 has two cover layers 2, 3, which are each produced from a first fiber-plastic composite material 4. In each of the two cover layers 2, 3, endless fibers 5 are arranged in a matrix plastic material 6 such that the fibers 5 extend in a longitudinal direction 7 over the entire flexible spring element 1. The longitudinal direction 7 corresponds to the progression of a center plane 8, which runs between two outwardly directed outer sides 9, 10 of the two cover layers 2, 3 equally spaced from the two outer sides 9, 10 respectively. In the exemplary embodiment depicted as an example, the progression of the center plane 8 also corresponds to the progression of a neutral fiber, which in the event of an intended force F respectively transverse to the longitudinal direction 7 at both end areas 11, 12 of the flexible spring element is not loaded. It is likewise conceivable, however, that the two cover layers 2, 3, for example, do not have the same thickness, so that the center plane 8 does not necessarily have to correspond to the progression of the neutral fiber.

The center plane 8 has an S-shaped progression. The flexible spring element 1 has two curved portions 13, 14 with a curved progression varying by approximately 180°, which portions are arranged respectively between two longitudinal portions 15, 16, 17. The two end areas 11, 12 are each formed by a longitudinal portion 15, 17, in which the flexible spring element 1 has an approximately linear progression of the center plane 8. Likewise formed between the two curved portions 13, 14 is a longitudinal portion 16, in which the center plane 8 runs approximately linearly and has a curvature reversal from the first curved portion 13 to the second curved portion 14.

In the longitudinal portions 15, 16 and 17, the two cover layers 2, 3 lying directly adjacent to one another are connected to one another, as depicted schematically in FIG. 3. The fibers 5 embedded into the matrix plastic material 6 of the cover layers 2, 3 run substantially parallel to the respective outer sides 9, 10 of the pertinent cover layer 2, 3 and extend in a longitudinal direction 7 over the entire flexible spring element 1. The orientation of the individual fibers 5 is accordingly perpendicular to the image plane in the sectional view depicted in FIG. 3 and runs within the image plane in the sectional view depicted in FIG. 1. In the event of a force F acting as intended on the flexible spring element, the fibers 5 are subjected to tensile loading substantially along the outer side portions 18 directed outwardly in the curved portion 13, 14 and subjected to compressive loading along the outer side portions 19 directed inwardly in the curved portion 13, 14.

A spacing extending element 20, 21 is formed in each of the two curved portions 13, 14. The spacing extending element 20, 21 produces a greater spacing between the outwardly directed outer side portions 18 and the inwardly directed outer side portions 19 of the two cover layers 2, 3 within the curved portions 13, 14 and thereby produces advantageous spring properties of the flexible spring element 1 in the region of the relevant curved portion 13, 14.

The two spacing extending elements 20, 21 have an approximately crescent-shaped design. The spacing extending element 20, 21 arranged in the respective curved portion 13, 14 between the two cover layers 2, 3 here has a continuously varying thickness in the longitudinal direction, so that the spacing extending element 20, 21 becomes continuously thicker starting out from a first end that tapers to a point and has a maximum thickness in a central area, to taper increasingly towards the opposing second end and likewise to taper to a point again. In this way abrupt thickness changes in the flexible spring element 1, which according to experience can lead to loading peaks and often extremely high and if applicable excessive loading during an intended use of the flexible spring element 1, can be avoided. The two spacing extending elements 20, 21 do not necessarily have to be configured symmetrically to the center plane 8.

Each of the two spacing extending elements 20, 21 is made of a second fiber-plastic composite material 22. The second fiber-plastic composite material 22 has the same matrix plastic material 6 as the first fiber-plastic composite material 4, so that the spacing extending elements 20, 21 are bonded substance-to-substance and homogeneously to the two adjacent cover layers 2, 3 without the mechanical strength of the flexible spring element 1 forming any impairing boundary surfaces between the spacing extending elements 20, 21 and the adjacent cover layers 2, 3.

Arranged in the matrix plastic material 6 of the second fiber-plastic composite material 22 are short fibers 23 of a preferably uniform length of between 1 mm and 5 mm. The short fibers 23 are oriented undirectedly in the spacing extending elements 20, 21, so that a substantially homogeneous distribution and a distribution oriented in all directions of the short fibers 23 is present in the matrix plastic material 6 of the second fiber-plastic composite material 22.

The dimensions of the spacing extending elements 20, 21 are dimensioned in particular with regard to the respective thickness transversely to the progression of the center plane 8 in such a way that the flexible spring element 1 has advantageous spring properties within the envisaged area of the force normally occurring and damage to the flexible spring element 1 is largely excluded. At the same time, the cover layers 2, 3 are also dimensioned so that an intended use of the flexible spring element 1 is possible beyond the envisaged duration of use and yet the minimum material is expended for the cover layers 2, 3 and the spacing extending elements 20, 21, so that the flexible spring element 1 has advantageous spring properties with a particularly low own weight.

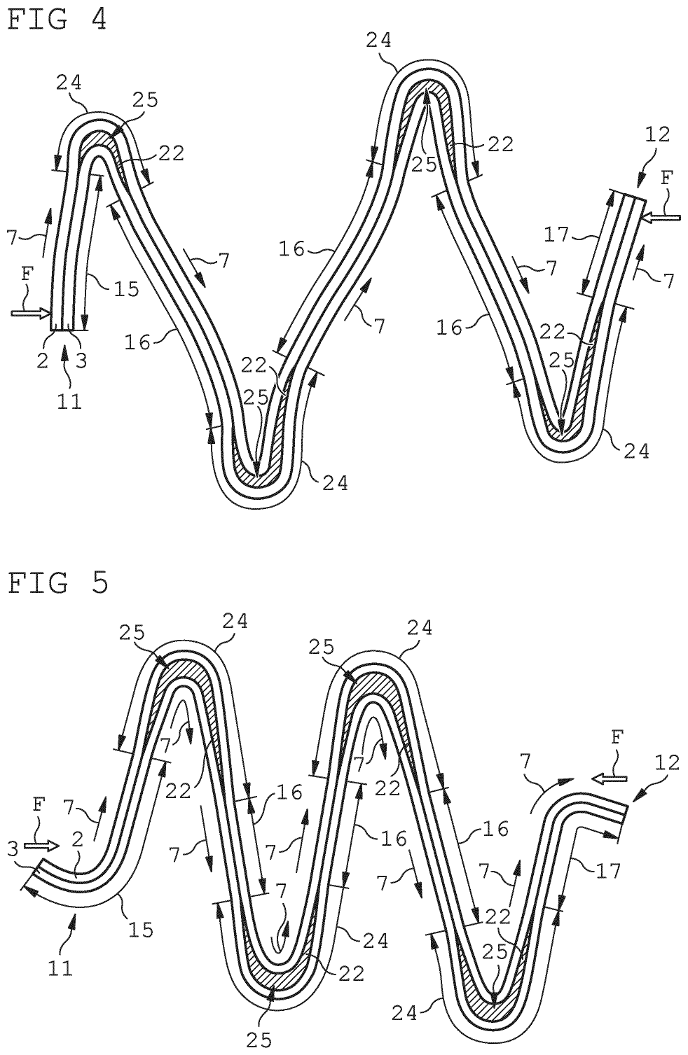

In FIGS. 4 and 5, a flexible spring element 1 is depicted respectively with more than two, or with four curved portions 24 in total. The individual curved portions 24 are each arranged between longitudinal portions 15, 16, 17 adjoining on both sides. Each of the flexible spring elements 1 shown by way of example in FIGS. 4 and 5 has several flexible spring portions configured in an S-shape and passing into one another. Arranged in each of the four curved portions 24 is a spacing extending element 25, which consists of the second plastic material 22 with the short and undirected fibers 23, which are embedded into the matrix plastic material 6.

The individual spacing extending elements 25 do not have to have a corresponding shape. On the contrary, the individual spacing extending elements 25 are adapted to the progression 7 of the respective flexible spring element 1 or to the progression 7 of the pertinent curved portion 24.

In the exemplary embodiment depicted in FIG. 4, the two end areas 11, 12 are oriented approximately parallel to one another and run in opposed directions, wherein an intended force predetermined by the definition of the flexible spring element 1 acts perpendicularly on the two end areas 11, 12. In the exemplary embodiment depicted in FIG. 5, the two end areas 11, 12 are likewise oriented parallel to one another and likewise run in opposed directions, but an intended force acts approximately in the direction predetermined by the orientation of the end areas 11, 12 or oriented in parallel to the two end areas 11, 12.

1.-8. (canceled)

9. A flexible spring element (1) made of a fiber-plastic composite material (4, 22), comprising
two cover layers (2, 3) made of a first fiber-plastic composite material (4) on each of two outer sides (9, 10) lying opposite one another,
wherein fibers (5) within the cover layers (2, 3) are aligned parallel relative to one another at least in bundles and run parallel to the outer side (9, 10) associated with the respective cover layer (2, 3);
at least one curved portion (13, 14, 25), in which a center plane (8) of the unloaded flexible spring element (1) running with equal spacing between the two cover layers (2, 3) runs in a curved manner in a longitudinal direction (7) of the flexible spring element (1);
at least one longitudinal portion (15, 16, 17) in which the center plane (8) of the unloaded flexible spring element (1) either has no significant curvature or has a reversal of curvature,
wherein in an intended deflection of the flexible spring element (1), a cover layer portion (18) arranged directed outwardly in the curved portion (13, 14, 25) is subjected to tensile loading and an opposing cover layer portion (19) directed inwardly in the curved portion (13, 14, 25) is subjected to compressive loading,
wherein the flexible spring element (1) comprises exclusively the two cover layers (2, 3) in the at least one longitudinal portion (15, 16, 17), and
wherein the at least one curved portion (13, 14, 25) the flexible spring element (1) comprises a spacing extending element (20, 21) made of a different material than the two cover layers (2, 3) arranged between the two cover layers (2, 3).

10. The flexible spring element (1) according to claim 9,
wherein the material of the spacing extending element (20, 21) is a second fiber-plastic composite material (22) with fibers (23), a length of which is less than 1 mm.

11. The flexible spring element (1) according to claim 10,
wherein the fibers (23) in the second fiber-plastic composite material (22) are arranged undirected.

12. The flexible spring element (1) according to claim 10,
wherein the second fiber-plastic composite material (22) comprises a matrix plastic material (6) corresponding to the two cover layers (2, 3).

13. The flexible spring element (1) according to claim 9,
wherein the center plane (8) in the at least one curved portion (13, 14, 25) of the flexible spring element (1) has a change of direction of more than 150°.

14. The flexible spring element (1) according to claim 9,
wherein the flexible spring element (1) comprises at least two curved portions (13, 14, 25) separated from one another by a longitudinal portion (15, 16, 17) and curved in different directions, so that the center plane (8) has an S-shaped progression over these two curved portions (13, 14, 25).

15. The flexible spring element (1) according to claim 9,
wherein the first fiber-plastic composite material (4) of the two cover layers (2, 3) comprises fibers (5) oriented unidirectionally in the longitudinal direction (7) of the flexible spring element (1).

16. The flexible spring element (1) according to claim 15,
wherein a length of the fibers (5) in a longitudinal direction (7) extends over the entire flexible spring element (1).
